(19) United States
(12) Patent Application Publication
(10) Pub. No.: US 2014/0349094 A1
(43) Pub. Date: Nov. 27, 2014

(54) MONOLITHIC MULTILAYER ARTICLE

(71) Applicant: 3M INNOVATIVE PROPERTIES COMPANY, St. Paul, MN (US)

(72) Inventors: James M. Jonza, Woodbury, MN (US); Duane D. Fansler, Dresser, WI (US); Joel A. Getschel, Osceola, MN (US); Ibrahim S. Gunes, Minneapolis, MN (US); Jeffrey P. Kalish, Minneapolis, MN (US); Matthew J. Schmid, Roberts, WI (US); Mark A. Strobel, Maplewood, MN (US); Chad R. Wold, West Lakeland, MN (US)

(21) Appl. No.: 14/363,123

(22) PCT Filed: Dec. 5, 2012
(86) PCT No.: PCT/US2012/067985

§ 371 Date: Jun. 5, 2014

Related U.S. Application Data
(60) Provisional application No. 61/567,488, filed on Dec. 6, 2011.

(51) Int. Cl. B32B 7/12; B32B 27/36; B32B 5/18

(52) U.S. Cl. CPC B32B 7/12; B32B 5/18; B32B 27/36; B32B 2305/022; B32B 2367/00; B32B 2307/738
USPC 428/215; 428/318.8; 428/315.9; 428/212; 428/213

(57) ABSTRACT

A monolithic multilayer article includes a thermoformable cellular polyester core layer and an oriented polyester skin layer on at least one major side of the polyester core layer.

### BACKGROUND

Core-skin composites have found widespread use owing to their combination of strength and light weight. Such composites often make use of a cellular core layer, and at least one skin layer adhered to the core layer so as to impart enhanced stiffness.

### SUMMARY

Herein is disclosed a monolithic multilayer article comprising a thermoformable cellular polyester core layer and an oriented polyester skin layer on at least one major side of the polyester core layer.

Thus in one aspect, herein is disclosed a thermoformable monolithic multilayer article comprising a thermoformable cellular polyester core layer; a first uniaxially-oriented or biaxially-oriented polyester skin layer on a first major side of the polyester core layer; and, a second uniaxially-oriented or biaxially-oriented polyester skin layer on a second major side of the polyester core, wherein the core layer and the first skin layer are self-bonded to each other and wherein the core layer and the second skin layer are self-bonded to each other.

These and other aspects of the invention will be apparent from the detailed description below. In no event, however, should the above summaries be construed as limitations on the claimable subject matter, whether such subject matter is presented in claims in the application as initially filed or in claims that are amended or otherwise presented in prosecution.

### BRIEF DESCRIPTION OF THE DRAWINGS

FIG. 1 is a side cross sectional view of an exemplary monolithic multilayer article.

FIG. 2 is a side cross sectional view of another exemplary monolithic multilayer article.

FIG. 3 is a side cross sectional view of one embodiment of a core layer of a monolithic multilayer article.

FIG. 4 is a side cross sectional view of another embodiment of a core layer of a monolithic multilayer article.

FIG. 5 is a side cross sectional view of one embodiment of a skin layer of a monolithic multilayer article.

FIG. 6 is a side cross sectional view of another embodiment of a skin layer of a monolithic multilayer article.

FIG. 7 is a side cross sectional view of an exemplary thermoformed monolithic multilayer article.

FIG. 8 is a perspective side view photograph of an exemplary thermoformed polyester laminate.

FIG. 9 is a side cross sectional view of an exemplary monolithic multilayer article.

Like reference numbers in the various figures indicate like elements. Some elements may be present in identical or equivalent multiples; in such cases only one or more representative elements may be designated by a reference number but it will be understood that such reference numbers apply to all such identical elements. Unless otherwise indicated, all figures and drawings in this document are not to scale and are chosen for the purpose of illustrating different embodiments of the invention. In particular the dimensions of the various components are depicted in illustrative terms only, and no relationship between the dimensions of the various components should be inferred from the drawings, unless so indicated. Although terms such as “top”, bottom”, “upper”, lower”, “under”, “over”, “front”, “back”, “outward”, “inward”, “up” and “down”, and “first” and “second” may be used in this disclosure, it should be understood that those terms are used in their relative sense only unless otherwise noted. As used herein as a modifier to a property or attribute, the term “generally” means that the property or attribute would be readily recognizable by a person of ordinary skill but without requiring absolute precision or a perfect match (e.g., within +/−20% for quantifiable properties). The term “subassembly” is used to signify a collection of components (e.g., layers that are bonded to each other) that may be assembled into a completed article (or into another subassembly).

### DETAILED DESCRIPTION

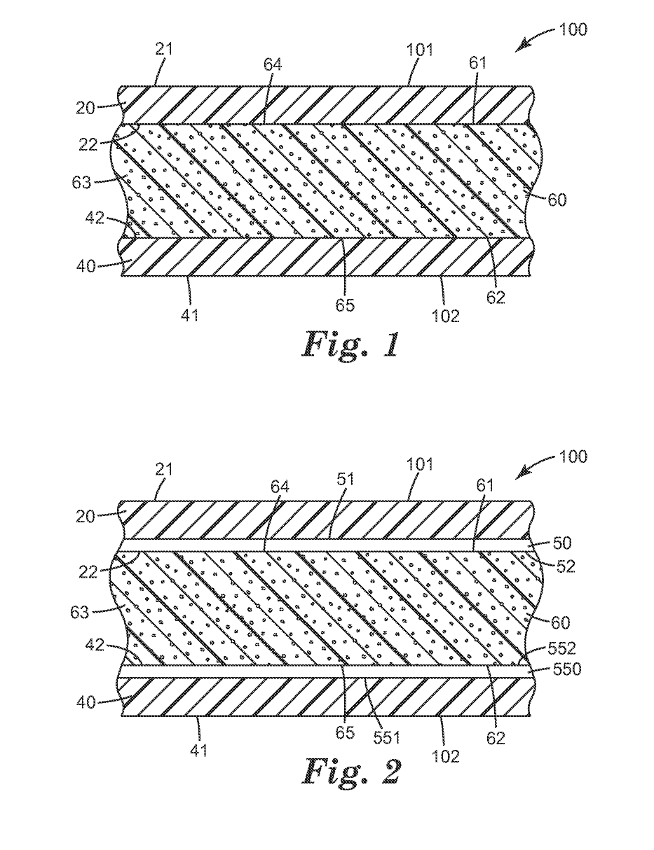

Disclosed herein is a monolithic multilayer article that may be thermoformable. Shown in FIG. 1 is a side cross-sectional view of an exemplary thermoformable monolithic multilayer article 100 comprising a thermoformable cellular polyester core layer 60, with a first polyester skin layer 20 disposed on first major side 61 of the core layer with first major surface 22 of first skin layer 20 facing first major surface 64 of the core layer; and, with a second polyester skin layer 40 disposed on second major side 62 of the polyester core with first major surface 42 of second skin layer 40 facing second major surface 65 of the core layer.

By a “monolithic multilayer article” is meant an article in which at least two polyester layers (e.g., substrates) are self-bonded to each other. With regard to the exemplary article of FIG. 1, core layer 60 and first skin layer 20 are self-bonded to each other and core layer 60 and second skin layer 40 may be self-bonded to each other. By “self-bonding” and “self-bonded” is meant bonding between adjacent polymeric materials (e.g., between major surface 64 of core layer 60 and major surface 22 of skin layer 20) of like composition, the bonding being achieved without the use of any adhesive or fastener that is of unlike composition from the adjacent polymeric materials. Such self-bonding thus excludes the presence, at the bonding interface between the adjacent materials, of any kind of adhesive such as e.g. pressure-sensitive adhesives, glues, hot-melt adhesives, UV-curable adhesives, etc.). Such self-bonding also excludes the use of any type of mechanical fastener as a necessary or essential aid to bonding the adjacent materials together.

By polymeric materials “of like composition” is meant polymeric materials that comprise compositions similar enough to each other that the materials exhibit melting points within 25 degrees C. of each other. It is further meant that the materials comprise polymer chains that are similar enough in molecular composition that chains from the adjacent materials can entangle with each other when brought near or to their melting points, sufficient to produce an acceptable melt-bond between the materials (when the materials are cooled). In specific embodiments, the materials of like composition may exhibit melting points that are within 10 degrees C., or 3 degrees C., of each other. (It will be recognized that such parameters will comprise the usual level of uncertainty inherent in measuring melting points by customary methods such as Differential Scanning calorimetry and the like). Above and beyond the above-presented general definition of polymeric materials of like composition, polyesters that comprise at least 90% by weight of the same monomer units (e.g., in which 90 wt. % of each polyester material is made from reacting of the same acid(s)/ester(s), with the same chain extender(s)) are of like composition as considered herein.

In some embodiments, self-bonding between a core layer and a skin layer may take the form of direct melt-bonding between a major surface of the core layer and a major surface of the skin layer. By “direct melt-bonding” and “directly melt-bonded” is meant placing such surfaces (e.g., surfaces 64 and 22 of FIG. 1) in direct contact with other so that polymer chains from the two materials entangle directly, with the result that when the materials are cooled and solidified an acceptably strong bond is formed therebetween. Such bonding may have the result that the polymer composition may be of like, or even identical, composition throughout the bonding zone (extending from the bonding surface of the core layer to the bonding surface of the skin layer). An exemplary multilayer article in which core layer 60 is directly melt-bonded to skin layer 20 and to skin layer 40 is shown in FIG. 1.

In other embodiments, self-bonding between a core layer and a skin layer may take the form of indirect melt-bonding between a major surface of the core layer and a major surface of the skin layer. By “indirect melt-bonding” and “indirectly melt-bonded” is meant providing a layer of molten polymeric material of like composition to that of both the core layer and the skin layer, in between adjacent and oppositely-facing major surfaces of the skin layer and the core layer, so that some polymer chains of the molten polymeric material entangle with polymer chains of the core layer, and some polymer chains of the molten polymeric layer entangle with polymer chains of the skin layer, so that the molten polymeric material (when cooled and solidified) bonds the core layer and the skin layer together. Such a molten polymeric material of like composition, when solidified, forms a tie layer of like composition to the core and skin layers and as such is distinguished from adhesives, heat-seal layers, etc., of unlike composition from the core and skin layers. Such bonding may have the result that the polymer composition may be of like, or even identical, composition throughout the bonding zone (extending from the bonding surface of the core layer, through the tie layer, and to the bonding surface of the skin layer). An exemplary multilayer article in which core layer 60 is indirectly meltbonded to skin layer 20 by way of tie layer 50, and is indirectly melt-bonded to skin layer 40 by way of tie layer 550, is shown in FIG. 2. In the illustrated embodiment, tie layer 50 comprises first major surface 51 that is melt-bonded to major surface 22 of skin layer 20, and second major surface 52 that is melt-bonded to major surface 64 of core layer 60. Likewise, tie layer 550 comprises first major surface 551 that is melt-bonded to major surface 42 of skin layer 40, and second major surface 552 that is melt-bonded to major surface 65 of core layer 60.

Thus in various embodiments, a core layer may be directly melt-bonded to both skin layers thereupon (as in FIG. 1), or may be indirectly melt-bonded to both skin layers thereupon (as in FIG. 2). Alternatively, a core layer may be directly melt-bonded to a first skin layer disposed upon a first major surface thereof, and indirectly melt-bonded to a second skin layer disposed upon a second major surface thereof.

As referenced above, by “melt-bonding” is meant bonding that is achieved by imparting thermal energy to adjacent polymeric materials (e.g., to at least the adjacent surfaces of such materials) of like composition, so as to raise at least the adjacent surfaces of the materials to a sufficiently high temperature (e.g., above their softening point; often, to or near their melting point) to allow entanglement to occur between polymer chains of the adjacent polymeric materials such that upon subsequent cooling of the materials, the adjacent polymeric materials are acceptably bonded together. Such melt-bonding thus does not require the use of any auxiliary adhesives, fasteners, etc. that are of unlike composition from that of the melt-bonded polymeric materials. In such melt-bonding, covalent bonds between polymeric chains of the adjacent polymeric materials may not be necessarily required; rather, they may be sufficiently held together by a combination of e.g. physical entanglement, polar interactions, electron sharing, acid-base interactions, hydrogen bonding, Van der Waals forces, and so on.

By “polyester” is meant any material in which at least about 70% by weight of the material is a homopolymer and/or copolymer (e.g., synthetic homopolymer or copolymer) having ester linkages, as may be formed e.g. by condensation polymerization methods. Suitable polyesters include e.g. those commonly made by condensation polymerization of hydroxyl-containing monomers and/or oligomers (e.g., chain extenders such as glycols and the like) with poly-acid-containing or poly-ester-containing monomers and/or oligomers (e.g., dicarboxylic acids or diesters such as terephthalic acid, naphthalene dicarboxylate, etc.). It should be noted that such polyesters may be made from poly-acids, or from any ester-forming equivalents of such materials (e.g., from any materials that can be polymerized to ultimately provide a polyester). Such polyesters also include those that may be industrially synthesized via bacterial fermentation, by ring-opening polymerization, cyclization, and so on. Recycled polyesters may also be used, e.g. alone or in combination with non-recycled polyesters.

Such polyesters may be made from any suitable hydroxyl-containing chain extender or combination of extenders. Commonly used chain extenders include for example the two-carbon diol, ethylene glycol (2G, when polymerized with terephthalic acids or esters yielding polyester “2GT”); the three-carbon diol, 1,3 propanediol (3G, when polymerized with terephthalic acids or esters yielding polyester “3GT”); and the four-carbon diol 1,4 butanediol (4G, when polymerized with terephthalic acids or esters yielding polyester “4GT”). Other names in use for 2GT are polyethylene terephthalate or PET, for 3GT are trimethylene terephthalate (PTT) or polypropylene terephthalate (PPT) and for 4GT polybutylene terephthalate or PBT. Polyesters as disclosed herein are not limited in the number of carbons (n) in the glycol monomer, as 6, 8, 10, 12, 18 as well as polymeric glycols (with e.g. 20<n<20,000, as exemplified by e.g. polyethylene glycol) are also well-known.

Such polyesters may be made from any suitable poly-acid-containing or poly-ester-containing monomers or oligomers or combination thereof. In some embodiments, such monomers or oligomers may be selected such that the resulting polyester is an aromatic polyester, as exemplified by e.g. poly(nG terephthalates), poly(nG isophthalates), poly(nG naphthalates), where n denotes the number of carbons in the glycol) and copolymers and/or blends thereof. In other embodiments, such monomers or oligomers may be selected such that the resulting polyester is an aliphatic polyester, as exemplified by polycaprolactone, poly(lactic acid), polyhydroxy alcanoates, polycyclohydroxy alcanoates and the like. Blends of any of the above polyesters (e.g., aliphatic with aromatic) may be used, as can aliphatic/aromatic copolymers such as poly-nG-adipate terephthalate, poly-nG-succinate terephthalate, poly-nG-sebacate terephthalate and other aliphatic/aromatic copolyesters Aliphatic cyclic glycols or cyclic acids/esters may also be used with either aliphatic or aromatic glycols and diacids or diesters. Examples include cyclohexane diols, cyclohexane dimethanols, benzene dimethanols, bisphenol A, cyclohexane dicarboxylic acids, norbornene dicarboxylic acids, biphenyl dicarboxylic acids and the like.

Some tri and tetra functional acids/esters or polyols may also be incorporated e.g. in amounts sufficient to increase chain branching, but low enough to avoid gelation. Useful examples include e.g. trimellitic acids, esters or anhydrides, trimethylol propane, pentaerythritol, epoxides, and epoxide functionalized acrylates.

Fully aromatic polyesters may be particularly useful e.g. if extreme temperature resistance is desired; examples of such materials include e.g. poly(BPA-terephthalate) and poly(4-hydroxy benzoate). Liquid crystalline polyesters (LCPs) may be useful (for a skin layer and/or a core layer). LCPs exhibit high modulus, low coefficient of thermal expansion, good hygroscopic and chemical stability, and inherent flame retardancy. Commercially available LCPs based on e.g. p-hydroxy benzoic acid, such as the product available from Ticona Engineering Polymers under the trade designation Vectra, are examples of suitable LCPs. In some embodiments, the polyesters may comprise fluorene moieties, as achieved e.g. by including reactants such as 9,9′-dihexylfluorene-2,7-dicarboxylic acid or 9,9-bis dihydroxy phenyl diol in the synthesizing of the polyester.

As mentioned above, the term “polyester” denotes that ester-linkage polymer chains make up at least about 70% by weight of the material (e.g., of a component such as a skin layer or core layer, and/or of a monolithic multilayer article as a whole). The remaining 30% may comprise any other ingredient(s) as used for any desired purpose. For example, other polymeric materials may be blended with the polyester for various purposes (e.g., for impact modification or the like). Or, inorganic additives such as mineral fillers, reinforcing fillers, pigments or the like may be used (e.g., talc, silica, clay, titania, glass fibers, glass bubbles, and so on). Other additives might include antioxidants, ultraviolet absorbers, chain extenders, anti-static agents, hindered amine light stabilizers, hydrolytic stabilizers, nucleating agents, mold releases, processing aids, flame retardants, coloring agents, slip agents, and so on. Any of these additives may be used in any desired combination. In some embodiments, one or more non-polyester polymers (such as e.g. polycarbonate) may be present as a blend with the polyester, e.g. at up to 5, 10, 20, or 30% by weight of the material. In other embodiments, non-polyester polymers may be limited to less than 5, 2, 1, or 0.5% by weight of the material.

In further embodiments, ester-linkage polymer chains make up at least about 80%, at least about 90%, at least about 95%, at least about 98%, or at least 99.5% of the weight of the material.

In various embodiments, the polyester is at least 70% by weight poly(ethylene terephthalate), at least 80% by weight poly(ethylene terephthalate), at least 90% by weight poly(ethylene terephthalate), or at least 95% by weight poly(ethylene terephthalate). In further embodiments, the polyester material consists essentially of poly(ethylene terephthalate), which condition will be understood as not precluding the presence of a small amount (e.g., less than about 2.0 mole %) of monomeric units derived from glycols other than ethylene glycol. For example, those of ordinary skill will appreciate that a small amount (e.g., about 1.5% or less) of diethylene glycol, triethylene glycol or the like may sometimes be substituted for ethylene glycol in the production of poly(ethylene terephthalate), in order to enhance the ability of the product to be e.g. biaxially-oriented. In some embodiments, ionic comonomers may be included e.g. to suppress crystallization in the cast sheet, enabling biaxial orientation so as to provide low haze, flat, birefringent and strong polyester films, as discussed in further detail in U.S. Patent Application Publication 2011/0051040, incorporated by reference herein. U.S. Pat. No. 6,875,803 and U.S. Pat. No. 6,794,432 are two other references to thermoformable polyester compositions.

In specific embodiments, the above-mentioned polymeric materials of like composition are materials in which at least 90% by weight of the polymeric material is poly(ethylene terephthalate). In further embodiments, such materials are those in which at least 97% by weight of the material is poly(ethylene terephthalate). In still further embodiments, such materials consist essentially of poly(ethylene terephthalate). It will be appreciated that the melting temperature of commonly available poly(ethylene terephthalate) is typically in the range of 250-260 degrees C.; often, about 256 degree C.

A monolithic multilayer article as disclosed herein comprises a first skin layer disposed on a first major side of a cellular core layer, and, optionally, a second skin layer, disposed on a second, oppositely-facing major side of the cellular core layer. A skin layer (e.g., skin layer 20 and/or skin layer 40) may be comprised of oriented polyester film. By “oriented” polyester film is meant polyester film that has been subjected at least to a uniaxial orienting process optionally followed by heat-setting (e.g., annealing at a temperature within about 50 degrees C. of the melting point of the polyester material) such that the polyester film exhibits at least one in-plane axis (e.g., along an oriented, e.g. downweb, direction of the film) with an elastic modulus of at least about 3 GPa (435 ksi) and a tensile strength of at least about 170 MPa (25 ksi), as measured in general accordance with the procedures of ASTM D882 as specified in 2010. In some embodiments, the oriented polyester film is a biaxially-oriented polyester film, with an elastic modulus along two in-plane orthogonal axes (e.g., downweb and crossweb) of at least about 3 GPa (435 ksi) and a tensile strength along those axes of at least about 170 MPa (25 ksi). In further embodiments, the biaxially-oriented polyester film may have an elastic modulus along two orthogonal in-plane axes of at least about 3.5 GPa (510 ksi), at least about 4.0 GPa (580 ksi), or at least about 4.5 GPa (650 ksi). In additional embodiments, the biaxially-oriented polyester film may have a tensile strength along two orthogonal in-plane axes of at least about 200 MPa (29 ksi) or of at least about 230 MPa (33 ksi). In various embodiments, the biaxially-oriented polyester film may comprise a % crystallinity of at least about 10, 20, 30, 40, or 50% (as measured by Differential Scanning calorimetry methods in which 100% crystallinity would correspond to a heat of fusion of approximately 140 J/g).

A polyester skin layer as disclosed herein may make use of any suitable polyester film (whether a single film makes up the skin layer, or a combination of films (a laminate) makes up the skin layer). In some embodiments, the polyester film is a dense film that is substantially free of porosity, cellular structures, and the like. In some specific embodiments, a polyester film may comprise a density of at least about 1.2, or 1.3, grams per cc. In further embodiments, the polyester film may exhibit a density of at most about 1.40 grams per cc. In some embodiments, the polyester film may be substantially free of reinforcing fibers (i.e., mineral fibers, glass fibers or the like). In further embodiments, the polyester film may be substantially free of fibers of any type or composition. (Those of ordinary skill will appreciate that as used here and in other contexts herein, the term substantially free does not preclude the presence of some extremely low, e.g. 0.1% or less, amount of material, as may occur e.g. when using large scale production equipment and the like).

In some embodiments, a polyester film for use as, or in, a polyester skin layer may be a microvoided polyester film, as described e.g. in U.S. Pat. No. 5,811,493. In some embodiments, a polyester film for use as, or in, a polyester skin layer may be a tear-resistant polyester film, as described e.g. in U.S. Pat. No. 6,040,061.

The earlier-presented definitions of the term “polyester”, and various embodiments directed to polyester compositions, while not repeated here, are specifically applicable to the polyester material of the polyester film layer.

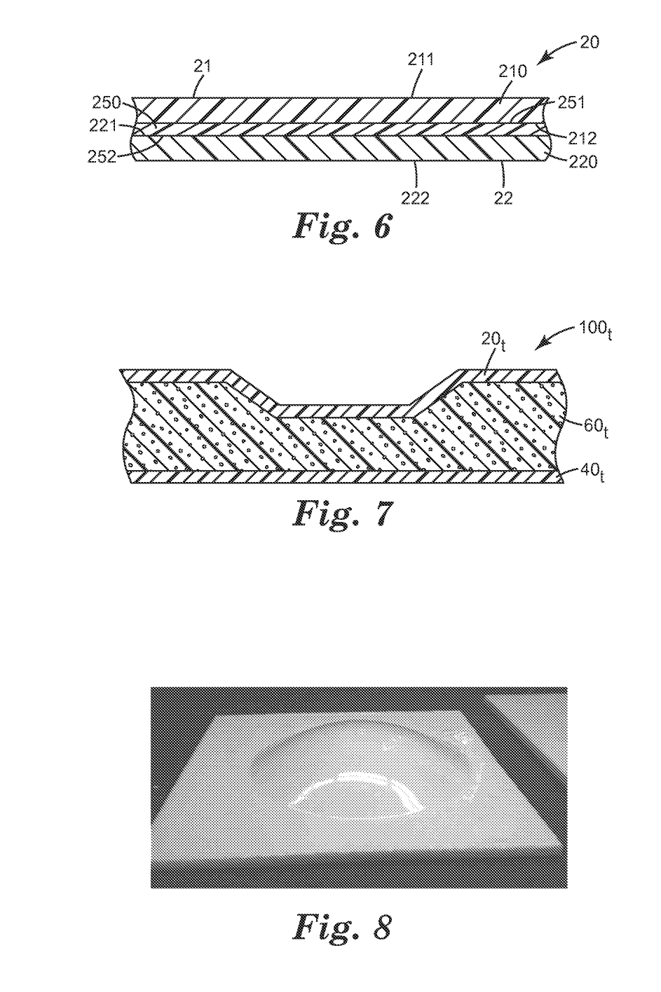

In various embodiments, a skin layer may be at least 10 microns in thickness (along the shortest dimension of the skin layer, e.g. between major surfaces thereof (with reference to exemplary skin layer 20 of FIG. 1, between surfaces 21 and 22). In further embodiments, a skin layer may be at least 50, 100, 200, 400, or even 600 microns in thickness. In some embodiments, a skin layer may be provided by a single polyester film of the desired skin layer thickness (as shown in exemplary illustration in FIG. 1); in other embodiments, a skin layer may be provided by a film laminate comprised of multiple sublayers (e.g., multiple polyester films) that combine to provide the desired total thickness of the skin layer. Skin layers comprising multiple sublayers are shown in exemplary illustration in FIGS. 5 and 6 and are discussed in further detail later herein (e.g., with reference to Example 6). In some embodiments, a skin layer may be at most 10, 5, or 2 mm (millimeters) in thickness.

In various embodiments, a polyester skin layer may comprise a coefficient of thermal expansion of at most about 35, 30, or 25 parts per million per degree C., measured, in a temperature range of approximately +20 to +60 degrees C., e.g. by the methods described in the Example section herein. It will be appreciated that in certain uses of the herein-disclosed monolithic multilayer articles (for example as reinforcing panels for automobiles and the like), such a comparatively low coefficient of thermal expansion may be well matched with that of metals (e.g., steel, aluminum, etc.) that are often used as structural components in automobiles. Thus, such a property (particularly when achieved without the use of e.g. reinforcing fibers, e.g. glass fibers, in the skin layers) may render the disclosed multilayer articles very well suited for such applications.

In some embodiments, a skin layer is a thermoplastic material (as may be distinguished from e.g. thermoset materials). In specific embodiments, the skin layer is thermoformable, as described in further detail later herein.

Exemplary skin layer 20 and exemplary skin layer 40 may share any of the above-discussed properties. Skin layer 40 may be identical, similar, or different, from skin layer 20, e.g. in thickness, physical properties, and the like. In some embodiments outward-facing major surface 21 of skin layer 20 may provide an outwardmost surface of article 100; similarly, in some embodiments outward-facing major surface 41 of skin layer 40 may provide an outwardmost surface (e.g., oppositely-facing from surface 21) of article 100.

Biaxially-oriented polyester films that may be suitable to form skin layers (whether such films are used as a single layer or are laminated together) include e.g. those products available from DuPont Teijin Films, Chester, Va., under the trade names Mylar and Melinex, and those products available from Mitsubishi Polyester GMBH, Weisbaden, Germany, under the trade name Hostaphan.

Any desired processing or treatment may be performed on a surface of a polyester skin layer and/or on a surface of a polyester film included in such a layer. Such processing might be performed before, or after the attachment of the film and/or skin to the cellular core layer, and/or before or after lamination of individual film layers to each other to form a skin layer (as described in detail later herein). Such processing might include e.g. plasma treatment, corona treatment, priming treatments, and the like, as appropriate for various purposes.

A monolithic multilayer article as disclosed herein comprises a cellular polyester core layer. By a “cellular polyester core layer” is meant any layer that comprises a polyester matrix with cells (e.g., cavities, pores, openings, etc.) therein, such that the core layer has an overall density (taking into account the cells) that is less than about 80% of the inherent density of the polyester matrix material itself (disregarding the cells). Such an overall density of a core layer sample may be calculated e.g. by measuring the ratio of the weight of the sample, to the overall volume (as defined by the outer dimensions) of the sample. In further embodiments, the cellular polyester core layer comprises an overall density that is less than about 60%, less than about 40%, or less than about 30%, of the inherent density of the polyester matrix material itself.

In various embodiments, the cellular polyester core layer may have an overall density of less than about 0.8, less than about 0.5, or less than about 0.2, grams/cc.

A cellular polyester core layer as defined herein specifically excludes fibrous polyester materials, such as nonwoven batts, fabrics, scrims and the like. In some embodiments, the cellular polyester core layer may be a generally incompressible substrate with a compressive modulus (Young's modulus in compression, as measured along the shortest dimension of the core layer at approximately 20 degrees C. according to generally known methods) of at least 6.2 MPa (900 psi). Those of ordinary skill will appreciate that such a property will distinguish such an incompressible cellular core layer from e.g. flexible foams and the like, which may be e.g. easily and reversibly compressible (e.g., by hand), at room temperature. In further embodiments, the cellular polyester core layer may exhibit a compression modulus of at least about 20, 50, or 100 MPa.

The earlier-presented definitions of the term “polyester”, and various embodiments directed to polyester compositions, while not repeated here, are specifically applicable to the polyester material of the cellular polyester core layer. (It is however noted that in the specific case of a cellular material, the compositional amounts, percentages, etc., mentioned in the previous discussions of polyester, are with reference only to the polyester (matrix) material itself, disregarding the empty or gas-filled cavity spaces of the core.)

In some embodiments, the cellular polyester core layer is a polyester foam layer. In certain embodiments, the polyester foam layer is a conventional polyester foam, made e.g. by the extrusion of a polyester melt comprising a chemical blowing agent such as azodicarbonamide. (Physical blowing agents such as carbon dioxide, nitrogen, and/or other gases can also be injected into the molten polyester prior to exiting the extrusion die.) Such conventional polyester foams often comprise an average cell size in the range of e.g. 0.1-3.0 mm. In other embodiments, the cellular core layer is a microcellular polyester foam, meaning that it has an average cell size of less than 100 microns. Often, such materials may have an average cell size of 50 microns or less; in some cases, in the range of about 10 microns or less. Such a microcellular polyester foam may be obtained e.g. by saturating a polyester material under pressure with a physical blowing agent such as carbon dioxide and then exposing the polyester material to an elevated temperature so that the material foams with a very high nucleation density. Suitable microcellular foams are available e.g. from MicroGREEN Polymers, Inc., Arlington, Wash., and are described in further detail in e.g. U.S. Pat. No. 5,684,055.

The cellular polyester core layer (whether e.g. a conventional foam or a microcellular foam), may comprise open cells, closed cells, or a mixture thereof. The foam layer may be integrally skinned (i.e., such that it has a relatively densified layer at one or both surfaces thereof); or, it may have open cells present at one or both surfaces. At least some of the cells of the core layer may be filled with air, although in some instances some cells may contain some level of residual gases left over from the generating of the cells. In some embodiments, no cells of the cellular polyester core contain or include any type of non-polyester polymeric resin.

The cellular polyester core layer may be thermoformable, meaning that it is made of a thermoplastic material that can be heated to a softening temperature at or above which it can be formed into a shape, and can then be cooled to maintain the formed portion of the layer in the formed shape. As such, a thermoformable polyester core layer is differentiated from non-thermoformable materials (irrespective of their composition). In particular, such a thermoformable layer is distinguished from thermoset materials that comprise such a number of permanent crosslinks that they cannot be satisfactorily thermoformed.

In some embodiments, the cellular polyester core may comprise a thickness (along the shortest dimension of the core layer) of at least 25 microns. In further embodiments, the cellular polyester core layer may comprise a thickness of at least 0.1 mm, 1 mm, 10 mm, or 100 mm. In additional embodiments, the cellular polyester core layer may comprise a thickness of at most 200 mm.

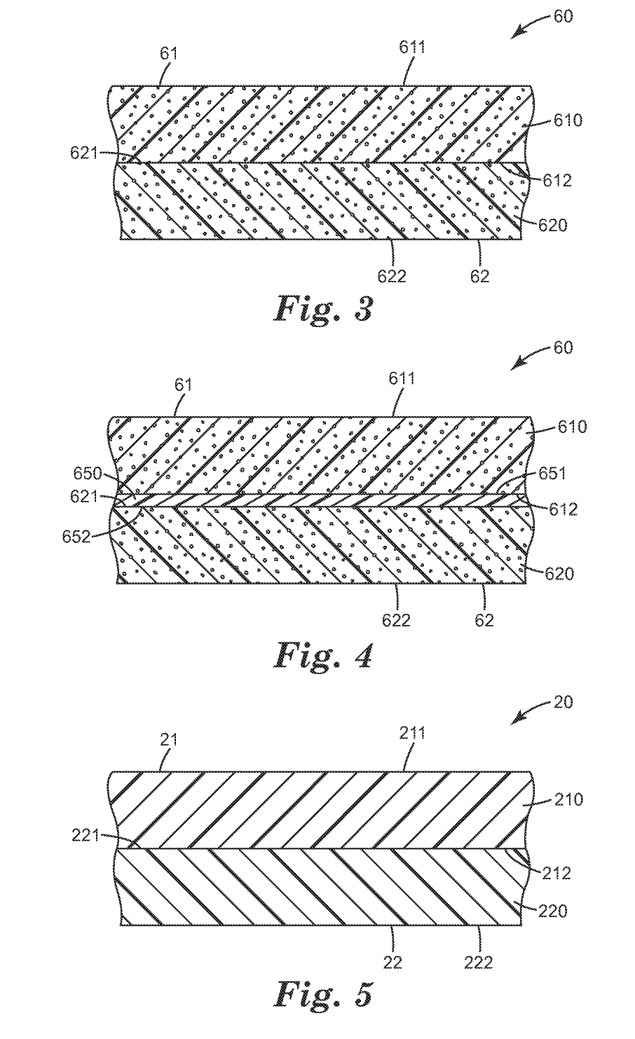

In some embodiments, a cellular polyester core layer may be comprised of a single cellular polyester layer of the desired core layer thickness (as in the exemplary illustration of FIG. 1); in other embodiments, a cellular core layer may be provided by a cellular laminate comprised of multiple cellular sublayers that combine to provide the desired total thickness of the cellular core layer. Such core layers comprising multiple sublayers are shown in exemplary illustration in FIGS. 3 and 4 and are discussed in further detail later herein.

As mentioned earlier herein and as shown in exemplary illustration in FIGS. 1 and 2, a monolithic multilayer article as disclosed herein may comprise a cellular polyester core layer, a first polyester skin layer on a first major side of the polyester core layer; and, an optional second polyester skin layer on a second major side of the polyester core. The first and second polyester skin layers may be identical to each other (e.g., in terms of thickness, in terms of being comprised of a single layer or of a certain number of sublayers, etc.), or may be different from each other. The first and second skin layers, and the cellular core layer, can respectively comprise any of the skin layer structures and properties, and core layer structures and properties, discussed herein. In particular embodiments, the skin layers may each be comprised of biaxially-oriented polyester film(s) and the cellular core layer may be comprised of a microcellular polymer foam.

In various embodiments, the monolithic multilayer article may comprise a total thickness of at least about 0.5 mm, 1 mm, 10 mm, or 100 mm. In further embodiments, the article may comprise a total thickness of at most about 200 mm. In various embodiments, the ratio of the thickness of a skin layer of the article, to the core layer of the article, may be at least 1.0:0.5, 1.0:1.0, 1.0:2.5, 1.0:5.0, 1.0:10, 1.0:100, or 1.0:200. In further embodiments, the ratio of a skin layer thickness to a core layer thickness may be at most 1.0:400, 1.0:200, 1.0:100, 1.0:10, 1.0:5.0, 1.0:2.5, or 1.0:1.0. It will be appreciated that in various circumstances, it may be desired e.g. to provide a modest increase in rigidity without adding significant weight, or to provide a large increase in rigidity at the cost of significant extra weight; thus the density, thickness, etc. of the core layer and skin layer(s) may be chosen as appropriate for the circumstance. In various embodiments, the overall density of the article (which density will be an aggregate of the density and volume of the core layer and of the skin layer(s), as well as any tie layers etc.) may range from e.g. 0.1 grams/cc, 0.2 grams/cc, 0.4 grams/cc, to 0.8 grams/cc, 1.0 grams/cc or 1.2 grams/cc. In various embodiments, the monolithic multilayer article may comprise a flexural modulus of at least 0.3 GPa (43 ksi), at least 0.7 GPa (100 ksi), at least 1.4 GPa (200 ksi), at least 2.1 GPa (300 ksi), or at least 2.8 GPa (400 ksi). In various embodiments, the article may comprise a flexural modulus of at least 0.7 GPa in combination with a density that is less than 0.5 grams/cc.

In some embodiments, the monolithic multilayer article is recyclable. By this is meant that at least the core and skin components of the article (e.g., core 60, skin 20, and skin 40 of exemplary article 100, and any tie layers as may be present) are sufficiently free of non-polyester materials so as to allow the article to be recycled using conventional polyester-recycling methods. Those of skill in the art will appreciate that an oft-used procedure in the recycling of polyester articles involves melting the polyester articles so that other materials (e.g., from other plastic articles made of materials with different melting points and/or densities, etc.), can be separated therefrom. As such, a recyclable polyester article will not contain an unacceptably high percentage of materials that might decompose or degrade at such melt-processing temperatures so as to release byproducts or the like that could serve to adversely impact the recycled polyester (that is, that might cause unacceptable discoloration, loss in molecular weight and/or physical properties, etc.).

Often, such recyclable polyester articles are recycled into polyester flakes, in which form they can be used (whether alone or in combination with some amount of virgin polyester) to make melt-processed articles, such as e.g. injection-molded or blow-molded articles, films, fibers, etc. In some instances, recycled polyester articles may be chemically broken down into constituent monomers or the like, and can subsequently be used to synthesize polymeric materials.

In particular embodiments, the recyclable multilayer article is comprised of at least about 95 wt. % poly(ethylene terephthalate). In further embodiments, the recyclable article is comprised of at least about 98 wt. % poly(ethylene terephthalate). In still further embodiments, the recyclable article consists essentially of poly(ethylene terephthalate).

In some embodiments, at least the core layer and skin layer(s) of the monolithic multilayer article comprise recycled polyester content. In this context, recycled polyester means polyester that has gone through a melt-recycling process and/or has been chemically broken down and repolymerized to polyester, as described above. In specific embodiments, the core layer and the skin layer(s) comprise at least 20, 40, or 80% by weight, recycled polyester content.

In some embodiments, the monolithic multilayer article can serve as a skin-core composite (e.g., a skin-core-skin sandwich composite). Sandwich composites (also known as I-beam composites and the like) have found widespread use owing to their combination of strength and light weight.

Often, conventional composites of this general type comprise a fiber reinforced thermoset skin adhered with a curable resin to a honeycomb or foam core. For flat articles, this is generally a well-accepted approach (except for the lack of recyclability of the article). However, to form a three-dimensional part, the process is much more complicated, slower and more expensive. Typically, the core must be pre-shaped by machining or preliminary thermoforming, the fiber reinforcements placed into the mold on both sides of the pre-shaped core, vacuum bagged, evacuated, resin infused and cured for several minutes to several hours depending upon the application. Such conventional composites thus often have complex and/or expensive components; may require long molding cycle times; and, may not be recyclable. In contrast, the herein-disclosed article can comprise a very simple structure; may be recyclable in at least some embodiments; and, (e.g. in view of the above-disclosed flexural modulus that it can achieve), may comprise adequate stiffness, strength, toughness, etc., for such applications. In particular, as mentioned earlier, an oriented polyester skin may comprise a coefficient of thermal expansion that is similar to that of e.g. a structural metal component adjacent which the article may be placed. Thus, the article may be particularly suitable for such uses.

In various embodiments, the monolithic multilayer article may comprise less than about 5 wt. % of non-polyester polymeric materials, which category includes (but is not limited to) e.g. chlorinated polymers, cellulosic polymers (e.g. wood-pulp or paper fibers), olefinic polymers, polyvinyl acetate polymers, ethylene-vinyl acetate polymers, epoxies, phenol-formaldehyde polymers, urea-formaldehyde polymers, styrenic polymers, polyurethanes, fluoropolymers, polyamides and the like. In further embodiments, the monolithic multilayer article comprises less than about 2 wt. %, about 1 wt. %, or about 0.5 wt. %, of such non-polyester polymers.

It will be appreciated that a monolithic multilayer article as described herein, comprising a cellular polyester core layer with an oriented polyester skin self-bonded to one or both sides/major surfaces thereof, is distinguished from a cellular polyester material that itself might comprise a dense skin at one or both surfaces (e.g., an integrally-skinned polyester foam). While such a cellular polyester material might be used to make in a multilayer article as disclosed herein (e.g., might serve as the core layer such a multilayer article), it cannot by itself serve as a monolithic multilayer article as disclosed herein. In particular, an integral skin of a polyester foam typically will not be an oriented material.

In some embodiments, the monolithic multilayer article is thermoformable, e.g. so that it can be formed into thermoformed article 100 as depicted in FIG. 7. (As used herein for convenience, the subscript “t” designates a component as described previously herein, but that is part of a multilayer article that has been thermoformed, although the specific component itself may or may not have been affected by the thermoforming). By “thermoformable” is meant that the multilayer article can be brought to an elevated temperature (e.g., to the glass transition temperature of e.g. at least the skin layer(s) of the article; often, above the glass transition temperature of both the skin layer(s) and the core layer) and then force applied thereto to form the article into a desired shape, after which the article is cooled with the formed shape being retained. Such thermoforming can be achieved by use of heat and pressure as supplied e.g. by well-known thermoforming methods and apparatus. Plug-assisted and pressure-assisted thermoforming, as well as compression molding, may be particularly applicable to the thermoforming of more rigid articles. In some embodiments, the thermoforming may be done in-line with (immediately following) any of the below-described bonding steps.

In some embodiments at least the cellular core layer of the article may be easily thermoformable such that portions of it may undergo e.g. a significant decrease in thickness (as depicted in core layer 60, of the exemplary illustration of FIG. 7), and/or may be stretched, and/or may be formed into a curved shape, etc. In such embodiments, either or both of the skin layers may be thermoformable at least to the extent that they may deform so as to follow the contours of thermoformed core 60ₜ. In such embodiments, one or both skin layers of thermoformed article 100ₜ may not necessarily undergo a significant change in thickness (e.g., as exemplified by skin layers 20ₜ and 40ₜ of the exemplary illustration of FIG. 7); or, they may e.g. only undergo a change in thickness at particular points of maximum curvature. In other embodiments, at least one skin layer of the article may be easily thermoformable. In such embodiments, the core layer may be thermoformable at least to the extent that it may deform so as to follow the contours of the thermoformed skin layer.

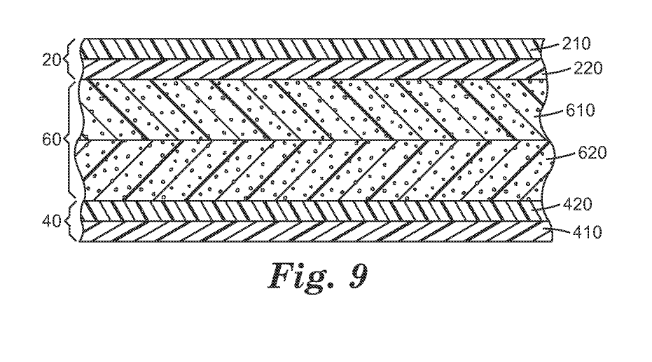

While the representative simplified illustration of thermoformed article 60, in FIG. 7 shows a simple representation of an area of decreased thickness in the thermoformed article, it will be understood that thermoforming can be used to produce complex shapes, curved and/or variable geometries, stretched portions, etc. It will also be understood that the thermoforming process may involve deformation of both major surfaces of an article (e.g., to make a structure of the general type shown in FIG. 8 and described in further detail in Example 9). Or, the thermoforming process may leave one skin layer (or, alternatively, a major surface of the core layer) generally undeformed, as shown in the exemplary illustration of FIG. 7). Likewise, the thermoforming process may result in deformation of only a portion of the thickness of the core layer, or in deformation of the entire thickness of the core layer, in at least an area of the core layer.

A monolithic multilayer article as disclosed herein may be made by any suitable method by which a first skin layer may be self-bonded to a first side of a cellular core layer and a second skin layer may be self-bonded to a second side of the cellular core layer. In some embodiments, a first major surface of a skin layer can be directly melt-bonded to a first major surface of a cellular core layer. Such melt-bonding may be done e.g. by conducting thermal energy through the thickness of a layer to the bonding surface of the layer (i.e., transmitting thermal energy into a back major surface of the layer, and then conducting the thermal energy from the back surface through the thickness of the layer to the front, bonding surface of the layer). Such melt-bonding can be performed e.g. by placing the layers in a bonding-surface-to-bonding-surface orientation in a platen press and applying heat and pressure thereto; or, by passing the layers in a bonding-surface-to-bonding-surface orientation through a heated nip roll or passing the layers between the belts of a double-belt lamination apparatus.

In some embodiments, the bonding may be “surface-bonding”, which is defined herein as bonding achieved by externally delivering thermal energy onto a first major bonding surface of a first moving substrate so that the first major bonding surface of the first moving substrate is a heated surface, externally delivering thermal energy onto a first major bonding surface of a second moving substrate so that the first major bonding surface of the second moving substrate is a heated surface; bringing the heated first major bonding surface of the first substrate into proximity to the heated first major bonding surface of the second substrate; and, self-bonding the first substrate and the second substrate to each other. By “externally delivering” thermal energy is meant delivering energy to a bonding surface of a substrate along a path that does not involve conducting the thermal energy through the thickness of the substrate. Such surface-bonding is thus distinguished from e.g. bonding in which thermal energy is delivered from the backside of the substrate (the side opposite the surface to be bonded), through the thickness of a substrate, to the bonding surface of the substrate. By a “moving substrate” is meant a substrate that is continuously moving generally along a long axis (e.g., machine direction) of the substrate, e.g. as occurs in the handling of substrates in conventional web-handling equipment.

Such surface-bonding so as to achieve direct melt-bonding of substrates to each other may be achieved e.g. by any suitable method of externally delivering thermal energy onto a bonding surface of at least one of the substrates to be bonded (i.e., the core layer, and/or one or both skin layers). In various embodiments, such methods might include impinging a flame on one or both bonding surfaces, or impinging electromagnetic radiation (such as e.g. infrared radiation, e.g. guided by a parabolic reflector) on one or both bonding surfaces, as evidenced in the Examples herein. In further embodiments, such methods might include impinging a heated gaseous fluid (e.g., hot air) on one or both of the bonding surfaces, optionally with local removal of the impinged heated fluid. Such methods of using impinged heated fluid to surface-bond substrates together are discussed in U.S. Patent Application Publication No. 2011/0151171, entitled Bonded Substrates and Methods for Bonding Substrates; and, U.S. Patent Application Publication 2011/0147475, entitled Apparatus and Methods for Impinging Fluids on Substrates, both of which are incorporated by reference herein.

In some embodiments such surface-bonding (however achieved) may be augmented or assisted by delivering thermal energy through the thickness of a substrate to be bonded, e.g. by passing the substrate over a heated backing roll, e.g. a nip roll, either prior to, during, or after the external delivering of thermal energy onto the bonding surface of the substrate. In other embodiments no delivery of thermal energy through the thickness of the substrate may occur. In various particular embodiments of this type, such a backing roll may not be actively heated or cooled; or, the backing roll may be actively temperature-controlled to a lower temperature than that of the substrate. In the latter case the backing roll may be controlled to a temperature such that no thermal energy is transferred into the bulk thickness of the substrate; or is may be controlled to a temperature such that thermal energy is removed from the bulk thickness of the substrate. In some embodiments, external delivery of thermal energy may be used to preheat at least the bonding surface of the substrate. For example, unfocused infrared radiation (as provided e.g. by a conventional IR lamp) may be directed onto the substrate. The substrate (along with the other substrate, to which it will be bonded) may then be bonded by any of the methods disclosed herein, e.g. by surface-bonding.

Further details of bonding substrates together, in particular surface bonding, are found in U.S. patent application Ser. No. ______, entitled Methods of Bonding Polyester Substrates, filed the same day as the present application, and incorporated by reference herein.

However achieved, direct melt-bonding of skin layers to a cellular core layer may provide a structure of the general type exemplified in FIG. 1. In other embodiments, indirect melt-bonding may be employed, such that skin layers are bonded to a cellular core layer by way of tie layers of like composition to the skin and core layers, as in the exemplary illustration of FIG. 2. As discussed previously herein, such bonding may be performed by providing a layer of molten polymeric material of like composition to that of both the core layer and the skin layer, in between adjacent, oppositely-facing major surfaces of the skin layer and the core layer. This may be achieved for example by extruding a molten thermoplastic polymer layer in between the surfaces to be bonded. It will be noted that such methods involve delivering thermal energy to the bonding surfaces of the substrates (e.g., the skin layers and the core layer) through a path that does not involve conducting the thermal energy through the thickness of the substrate. (In this case, thermal energy is carried by the molten extruded polymer material, and is transmitted therefrom to the bonding surface of each substrate when the molten material contacts each bonding surface). Thus, the extruding of a molten layer of polymer of like composition between bonding surfaces of substrates to be bonded, falls within the above definition of surface-bonding.

In various embodiments, tie layers as may be provided as described above may comprise a thickness of from about 12-200 microns, about 25-125 microns, or about 50-100 microns. Such tie layers may be comprised of polyester as discussed earlier herein. The above-presented definitions of the term “polyester”, and various embodiments directed to polyester compositions, while not repeated here, are specifically applicable to the polyester material of the tie layer. It will be appreciated, however, the such tie layers, not having gone through an orientation process, may not necessarily comprise orientation of the type that may be exhibited by the skin layers.

In some embodiments, a bonding surface (or surfaces) of a substrate to be bonded (e.g., a skin layer and/or a core layer), may be an amorphous surface. A common approach known in the polyester film art is to coextrude an amorphous polyester layer onto one or both surfaces of e.g. a semicrystalline polyester film. Such amorphous polyesters are commonly known in the art, as exemplified by the materials commonly referred to as aPET or PETG. A sufficient fraction of comonomer content may be used so that upon orientation, the material may not crystallize (even if present as a layer upon a crystallizable polyester layer) but rather remains amorphous. Such amorphous layers are commonly extruded in the range of 25-140 microns, e.g. onto crystallizable polyester films, and may thin down following orientation of the multilayer film to the range of e.g. 1.5 to 10 microns in thickness.

In some embodiments a bonding surface (or surfaces) of a substrate to be bonded may be a flashlamped surface. A flashlamped surface as defined herein is a polymer surface that has been suitably exposed to pulses of electromagnetic radiation (e.g., UV radiation) such that the surface of the polymer substrate, and a shallow layer therebeneath (often, extending no deeper than e.g. about 600 nanometers into the interior of the polymeric substrate) has been transformed (e.g. from a crystalline or semicrystalline state) into a quasi-amorphous state. It will be recognized that such a quasi-amorphous state differs from an amorphous state in having long-range ordering typical of crystalline structures and having short-range non-orientation or low orientation, as discussed in U.S. Pat. No. 4,879,176. As such, a quasi-amorphous (flashlamped) polyester surface can be distinguished from a (conventional) amorphous polyester surface by various analytical methods, again as discussed in U.S. Pat. No. 4,879,176. Further details of the flashlamping process and of flashlamped surfaces of polymeric substrates may be found in U.S. Pat. Nos. 5,032,209, 4,879,176, and 4,822, 451, all of which are incorporated by reference herein.

Thus in reference to the exemplary illustrations of FIGS. 1 and 2, any or all of at least surface 22 of skin 20, surface 42 of skin 40, and surfaces 64 and 65 of core layer 60, may be flashlamped surfaces.

In some embodiments, the flashlamping of a bonding surface of one or both substrates to be bonded, can be performed in-line with (e.g., upstream of, and immediately prior to) any of the bonding processing disclosed herein.

As was mentioned earlier, in some embodiments a cellular core layer may take the form of a single layer of cellular material (as exemplified by core 60 of FIG. 1); or, in other embodiments, a cellular core layer may be comprised of multiple sublayers (e.g., substrates) of cellular material that are bonded together to form a cellular laminate that serves as the core layer. In these other embodiments, such cellular sublayers may be self-bonded to each other, whether by such methods as conventional melt-bonding, or by surface-bonding as discussed above.

An exemplary cellular core layer 60 that is a cellular laminate comprised of self-bonded cellular sublayers 610 and 620 is depicted in FIG. 3. First and second cellular sublayers 610 and 620 may respectively comprise bonding surfaces 612 and 621, which may be directly melt-bonded to each other as depicted in FIG. 3. (Major surfaces 611 and 622 may be self-bonded e.g. to major surfaces of polyester skin layers, as described previously herein.) In an alternative embodiment, bonding surfaces 612 and 621 of first and second cellular sublayers 610 and 620 may be indirectly melt-bonded to each other by tie layer 650 of like composition, as shown in FIG. 4. In such a case, opposing major surfaces 651 and 652 of tie layer 650 may be respectively self-bonded to surfaces 612 and 621 of cellular sublayers 610 and 620.

Although the illustrations of FIGS. 3 and 4 depict only two cellular sublayers, any number of cellular sublayers may be combined to form a cellular laminate that serves as the cellular core layer. Thus, for example, if cellular sublayers (e.g., microcellular polyester foam substrates) of 2 mm thickness are available, four such sublayers may be self-bonded together to form a cellular laminate of e.g. about 8 mm thickness (plus the thickness of any tie layers that might be used in bonding the sublayers together, if the core layer is of the type shown in FIG. 4). Such a cellular laminate may then serve as a cellular core layer.

Surfaces of cellular sublayers may be flashlamped surfaces so as to enhance their melt-bonding to surfaces of adjacent cellular sublayers in the forming of a cellular-laminate core layer and/or to enhance their melt-bonding to surfaces of an adjacent skin layer or sublayer.

While not shown in any figure, in some embodiments a dense polyester film sublayer (e.g., of the general type described below in reference to producing a multilayer skin layer) may be sandwiched in between two cellular sublayers of a cellular laminate. It will thus be appreciated that in view of such embodiments (as well as in embodiments in which a tie layer may be used to bond cellular sublayers together to make a core layer, as in FIG. 4), the term cellular core layer encompasses constructions with layers of cellular material interspersed with one or more layers of dense material (rather than being limited to only cellular layers with a generally cellular interior 63, as in the particular embodiment of FIG. 1).

As was mentioned earlier, in some embodiments a skin layer may take the form of a single layer (i.e., a single oriented polyester film); or, in other embodiments, a skin layer may be comprised of multiple film sublayers (i.e., each sublayer may be a polyester film substrate) that are bonded together to form a film laminate. In embodiments in which the sublayers are biaxially-oriented polyester films, such a laminate of sublayers will be termed a biaxially-oriented polyester film laminate. Film sublayers may be self-bonded to each other to form film laminates, whether by such methods as conventional melt-bonding, or by surface-bonding, as discussed herein.

An exemplary skin layer 20 that is a film laminate comprised of polyester film sublayers 210 and 220 is depicted in FIG. 5. First and second sublayers 210 and 220 may respectively comprise bonding surfaces 212 and 221, which may be directly melt-bonded to each other as in FIG. 5. (Major surface 211 may be self-bonded to a major surface of a cellular core layer; or, may serve as an outwardmost surface of the final multilayer article; similarly for major surface 222.) In alternative embodiments, bonding surfaces 212 and 221 of first and second film sublayers 210 and 220 may be indirectly melt-bonded to each other by tie layer 250, as shown in FIG. 6. In such case, opposing major surfaces 251 and 252 of tie layer 250 may be respectively melt-bonded to surfaces 212 and 221 of film sublayers 210 and 220.

Although the illustrations of FIGS. 5 and 6 only depict two such film sublayers, any number of film sublayers may be combined to form a film laminate that can serve as a skin layer. Thus, for example, if film sublayers (e.g., biaxially-oriented polyester films) of 100 microns thickness are available, three such sublayers may be bonded together to form a film laminate of e.g. about 300 microns thickness (plus the thickness of any tie layers that might be used in bonding the sublayers together if the film laminate is of the type shown in FIG. 6). Such a film laminate may then serve as a skin layer.

Surfaces of film sublayers may e.g. be amorphous surfaces, or quasi-amorphous surfaces (e.g. flashlamped surfaces), so as to enhance their bonding to surfaces of adjacent film sublayers in the forming of a film-laminate skin layer and/or to enhance their bonding to surfaces of an adjacent core layer or sublayer.

A monolithic multilayer article as disclosed herein may be comprised of any combination of the above-described layers and/or sublayers. That is, a cellular core layer, whether comprised of a single layer of cellular material, of multiple sublayers of cellular material that are directly melt-bonded to each other, of multiple sublayers of cellular material that are indirectly melt-bonded to each other, of multiple sublayers of cellular material with one or more dense (noncellular) layers interspersed therebetween, and so on, may be combined with first and second skin layers, whether such skin layers be comprised of a single layer, of multiple film sublayers that are directly melt-bonded to each other, of multiple film sublayers that are indirectly melt-bonded to each other, and so on. The first and second skin layers may be identical and/or symmetrical to each other, or may be different from each other.

An exemplary monolithic multilayer article comprising a cellular core 60 that is a cellular laminate comprising two cellular sublayers 610 and 620, and that comprises first skin layer 20 that is a film laminate comprising two film sublayers 210 and 220, and that comprises a second skin layer 40 that comprises two film sublayers 410 and 420, is shown in FIG. 9.

In assembling a monolithic multilayer article, processing steps (e.g., bonding steps) can be performed in any convenient order. In embodiments in which the cellular core layer is provided by a single layer of cellular material, a first skin layer can be bonded to a first side/surface of the core layer, and a second skin layer can be bonded to the second side/surface of the core layer. (Both skin layers might be bonded to the core layer generally simultaneously; or, they may be bonded sequentially.) Either or both skin layers may be comprised of a single film layer; or, either or both may be a film laminate as described earlier herein, comprising multiple film sublayers. If a film layer is to be a film laminate comprised of film sublayers, the sublayers may e.g. be bonded to each other to form the film laminate, which may then be bonded to the cellular core layer.

If the cellular core layer is to be a cellular laminate comprised of cellular sublayers, variations on the bonding/assembly process are possible. In a first general approach, two or more cellular sublayers may be bonded together to form the cellular core layer, after which first and second skin layers may be bonded to the first and second major surfaces of the cellular core layer to form the monolithic multilayer article. In a second general approach, a cellular sublayer may be provided, and a skin layer may be bonded onto one major surface of the cellular sublayer to form a subassembly which for convenience will be termed a cellular/skin laminate subassembly. Such a cellular/skin laminate subassembly may comprise an exposed major surface of a cellular sublayer on one side, and a skin layer on the other side. Another such cellular/skin laminate subassembly may be made, after which the exposed major surfaces of the cellular sublayers of each cellular/skin laminate subassembly may be bonded together to form the final monolithic multilayer article. A monolithic multilayer article may thus be formed comprising a cellular laminate core layer that is comprised of two cellular sublayers (e.g., in similar manner to the exemplary article of FIG. 9), with skin layers bonded to the outwardmost major surfaces of the core layer (in the exemplary illustration of FIG. 9, both skin layers are film laminates that comprise two film sublayers).

It will be appreciated that this second general approach is an example of an approach in which the cellular core layer of a monolithic multilayer article is not formed until the final bonding/assembly step.

In a slight variation on this second general approach, instead of starting with a single cellular sublayer, two (or more) cellular sublayers may be bonded together to form a structure which for convenience will be referred to herein as a cellular laminate subassembly. A skin layer may then be bonded onto one major surface of the cellular laminate subassembly, to form a cellular/skin laminate subassembly (akin to that described in the previous paragraph, except that the cellular portion of the subassembly is comprised of two cellular sublayers rather than one cellular sublayer). Such a cellular/skin laminate subassembly may comprise an exposed major surface of a cellular sublayer on one side, and a skin layer on the other side. A second such cellular/skin laminate subassembly may be made (which may have the same number of cellular sublayers, or a different number of cellular sublayers, as the first subassembly), after which the exposed major surfaces of the cellular sublayers of each cellular/skin laminate subassembly may be bonded together to form the final monolithic multilayer article. Again, in this approach, the cellular core layer may not be formed until the final bonding/assembly step.

To summarize, in embodiments falling within the first general approach, one or both skin layers may be bonded to major surfaces of an existing cellular laminate core layer, as the final step in the production of a monolithic multilayer article. In embodiments falling within the second general approach, subassemblies may be made and then bonded together, such that the cellular laminate core layer is not formed until the final bonding/assembly step in producing the article.

Embodiments falling within the second general approach may have advantages in some circumstances. For example, it may be convenient to order the bonding operations such that subassemblies (e.g., cellular/skin laminates) are produced that are able to be handled e.g. on conventional laminating equipment (e.g., subassemblies are produced that can deform so that they can pass around curved surfaces of lamination rolls and the like). Such subassemblies can then be bonded together to form the final monolithic multilayer article, as the final step in the assembly of the article. Such an approach may be more convenient than e.g. producing a fully-completed cellular core layer comprising multiple sublayers (which core layer may be stiff and e.g. difficult to handle in roll-good format), and then bonding skins to the outwardmost surfaces of the completed core layer to form the final article.

By way of a specific example falling within the second general approach, a biaxially-oriented skin layer may be self-bonded to a first major surface of a thermoformable cellular sublayer, to form a first thermoformable-cellular/biaxially-oriented-skin laminate subassembly. A second such thermoformable-cellular/biaxially-oriented-skin laminate subassembly (which may or may not be identical to the first) may be formed. These first and second subassemblies can then be attached to each other, by self-bonding the remaining exposed major surfaces of the cellular sublayers of the two subassemblies to each other. Thus will be formed a monolithic multilayer article comprising a cellular laminate core layer that is comprised of first and second cellular sublayers that are self-bonded to each other, and comprising first and second biaxially-oriented skin layers that are self-bonded to the cellular core layer.

In a second specific example again falling within the second general approach, two thermoformable cellular sublayers may be self-bonded to each other to form a thermoformable-cellular laminate subassembly. A biaxially-oriented skin layer may be self-bonded to a first major surface of the thermoformable-cellular laminate subassembly. Thus is formed a first thermoformable-cellular laminate/biaxially-oriented-skin laminate subassembly (akin to that of the previous paragraph, except that the cellular portion of the subassembly is comprised of two cellular sublayers rather than one). A second such thermoformable-cellular laminate/biaxially-oriented-skin laminate subassembly (which may or may not be identical to the first) may be formed. These first and second subassemblies can then be attached to each other, by self-bonding the remaining exposed major surfaces of the cellular sublayers of the two subassemblies to each other. Thus will be formed a monolithic multilayer article comprising a cellular laminate core layer that is comprised of four cellular sublayers (two from each subassembly) that are self-bonded to each other, and comprising first and second biaxially-oriented skin layers that are self-bonded to the cellular core layer.

In the above approaches, subassemblies that are mated together may or may not be symmetrical and/or identical (e.g., they may or may not have the same number of cellular sublayers, may or may not have cellular sublayers of the same thickness, may or may not have the same number of film layers in the skin layer, may or may not have skin layers of the same total thickness, and so on).

As mentioned, in any of the above embodiments, a skin layer may be used that is comprised of multiple film sublayers (in the terms used above, the skin layer may be comprised of a film laminate) rather than a single layer of polymer film.

Specific exemplary methods and arrangements for assembling multiple sublayers into a monolithic multilayer article are presented in the Examples.

In some embodiments, additional components (e.g., layers of material, etc.) may be added to (e.g., attached to) the monolithic multilayer article. Such additional components might be e.g. positioned upon major outward-facing surface 101 of article 100 (which major surface may be e.g. supplied by major outward-facing surface 21 of skin 20); or, positioned upon major outward-facing surface 102 of article 100 (which major surface may be supplied by major outward-facing surface 41 of skin 40), both with reference to FIGS. 1 and 2. Such additional components may be provided for any purpose as desired (for example, for protection, to enable placement or attachment of the article in a desired location e.g. of an automobile panel, and so on). In particular embodiments, an ornamental or decorative layer may be provided as an outermost layer of at least one major side of the article. It may be advantageous that, if such additional components are present, they may be easily removable when desired, e.g. so as to facilitate recycling of article 100. In alternative embodiments, the monolithic multilayer article consists essentially of a cellular polyester core layer, and first and second polyester skin layers self-bonded to major surfaces thereof, which condition precludes any such additional components. In some specific embodiments, the monolithic multilayer article is substantially free of any adhesive (e.g., pressure-sensitive adhesive, photocurable adhesive, thermally curable adhesive, solvent-based adhesive, aqueous or water-based adhesive, hot-melt adhesive, glue, and so on), meaning that any adhesive, if present, comprises less than 0.1 weight percent of the combined weight of the core layer and skin layer(s) of the article.

Given the above discussions, it will be appreciated that at least a certain amount of non-polyester material (e.g., whether in the guise of a non-polyester component such as a tie layer, a primer, a cover layer, a decorative or ornamental layer, an adhesive, etc.; or, in the guise of non-polyester additives that may be present in a polyester film and/or cellular layer, etc.) may be present in the article, except as precluded in various specific embodiments discussed herein.

Although the discussions herein have focused in general on exemplary embodiments of the type in which a cellular core layer comprises a first skin layer on a first major side thereof, and a second skin layer on a second major side thereof, it will be appreciated that the disclosures herein encompass configurations in which a skin layer (which again, may comprise any number of sublayers) is provided only on one major side of the core. Furthermore, while the discussions herein have centered in general on the use of the herein-described articles in e.g. automotive applications and the like, it will be appreciated that the articles disclosed herein may be used in any suitable application. That is, such articles may be used in any instance in which it is e.g. desired to provide an article containing a cellular core, in which the article comprises a stiffness (as characterized e.g. by flexural modulus) that is greater than that of the cellular core layer alone. The articles of this invention thus may be useful as components of construction panels, signing substrates, partitions, furniture, temporary shelter or housing, protective equipment or attire, mobile homes and trailers, electric vehicles, boats, aircraft, motor sports, human powered vehicles, and any other applications that can benefit from the combination of properties described herein.

### LIST OF EXEMPLARY EMBODIMENTS

### Embodiment 1

A thermoformable monolithic multilayer article comprising a thermoformable cellular polyester core layer; a first uniaxially-oriented or biaxially-oriented polyester skin layer on a first major side of the polyester core layer; and, a second uniaxially-oriented or biaxially-oriented polyester skin layer on a second major side of the polyester core, wherein the core layer and the first skin layer are self-bonded to each other and wherein the core layer and the second skin layer are self-bonded to each other.

### Embodiment 2

The article of embodiment 1 wherein a first major surface of the core layer and a first major surface of the first skin layer are directly melt-bonded to each other.

### Embodiment 3

The article of embodiment 1 wherein a first major surface of the core layer and a first major surface of the first skin layer are indirectly melt-bonded to each other by a polyester tie layer that comprises a first major surface that is self-bonded to the first major surface of the core layer and a second major surface that is self-bonded to the first major surface of the first skin layer.

### Embodiment 4

The article of any of embodiments 1-3 wherein the first and second skin layers are each at least 250 microns in thickness.

### Embodiment 5

The article of any of embodiments 1-4 wherein the first skin layer comprises a first major surface that faces a first major surface of the core layer and that is an amorphous surface or a quasi-amorphous flashlamped surface

### Embodiment 6

The article of any of embodiments 1-5 wherein the core layer comprises a first major surface that faces a first major surface of the first skin layer and that is an amorphous surface or a quasi-amorphous flashlamped surface.

### Embodiment 7

The article of any of embodiments 1-6 wherein a first major surface of the skin layer that faces a first major surface of the core layer, a first major surface of the second skin layer that faces a second major surface of the core layer, and the first and second major surfaces of the core layer, are all amorphous surfaces or quasi-amorphous flashlamped surfaces.

### Embodiment 8

The article of any of embodiments 1-7 wherein the core layer comprises a polyester foam.

### Embodiment 9

The article of any of embodiments 1-8 wherein the core layer comprises a microcellular polyester foam.

### Embodiment 10

The article of any of embodiments 1-9 wherein the core layer comprises at least two thermoformable cellular polyester sublayers that are self-bonded to each other.

### Embodiment 11

The article of any of embodiments 1-10 wherein at least the first skin layer comprises at least two biaxially-oriented polyester film sublayers that are self-bonded to each other.

### Embodiment 12

The article of any of embodiments 1-11 wherein the first skin layer, the second skin layer, and the core layer, each consist essentially of ester-linkage polymer chains.

### Embodiment 13

The article of any of embodiments 1-12 wherein the first and second skin layers and the core layer are all polyesters of like composition with a melting point within 10 degrees C. of each other.

### Embodiment 14

The article of any of embodiments 1-13 wherein the polyesters of like composition are chosen from the group consisting of poly(ethylene terephthalate), poly(ethylene naphthalate), poly(butylene terephthalate), and copolymers of like composition thereof.

### Embodiment 15

The article of any of embodiments 1-14 wherein the polyesters of like composition all consist essentially of poly(ethylene terephthalate).

### Embodiment 16

The article of any of embodiments 1-15 wherein either the core layer or the skin layers or both, consist of recycled polyester.

### Embodiment 17

The article of any of embodiments 1-16 wherein the article is recyclable.

### Embodiment 18

The article of any of embodiments 1-17 wherein the first skin layer and the second skin layer and the core layer are both substantially free of fibers.

### Embodiment 19

The article of any of embodiments 1-18 wherein the article is substantially free of adhesive.

### Embodiment 20

The article of any of embodiments 1-19 wherein the article consists essentially of: a thermoformable cellular polyester core layer; a first biaxially-oriented polyester skin layer on the first major side of the polyester core layer; and, a second biaxially-oriented polyester skin layer on the second major side of the polyester core, wherein the polyester core layer and the first polyester skin layer are self-bonded to each other and wherein the polyester core layer and the second polyester skin layer are self-bonded to each other.

### Embodiment 21

The article of any of embodiments 1-20 wherein the skin layers each have a coefficient of thermal expansion of less than 35 parts per million per degrees C. as measured over a range within +20 degrees C. to +60 degrees C.

### Embodiment 22

The article of any of embodiments 1-21 wherein the multilayer article exhibits a flexural modulus of at least 0.7 GPa.

### Embodiment 23

The article of any of embodiments 1-22 wherein the article comprises a density of less than 0.8 grams/cc.

### Embodiment 24

The article of any of embodiments 1-23 wherein the ratio of the thickness of the first skin layer to the thickness of the core layer, is between 1:2.5 and 1:10.

### Embodiment 25

The article of any of embodiments 1-24 wherein the article is a thermoformed article.

### Embodiment 26

A thermoformable monolithic multilayer article comprising a thermoformable cellular polyester core layer and a uniaxially-oriented or biaxially-oriented polyester skin layer on a first major side of the polyester core layer, and wherein the core layer and the skin layer are self-bonded to each other.

### EXAMPLES

The following working examples illustrate various exemplary monolithic multilayer articles and the production thereof.

Test Methods

The coefficient of thermal expansion of substrates, e.g. in the range of +20 to +60 C, may be evaluated according to the following general procedure. A film sample may be cut into a strip (e.g., 1 inch wide) and mounted on a frictionless slide and an initial length recorded. A slot oven is then slid over the sample and the test strip is heated to a desired hold temperature. After a predetermined time, the sample length is recorded, the oven is disengaged, and the sample is allowed to cool back to room temperature and the final sample length is recorded (a laser telemetric system may be used to measure the sample length). Throughout the test, the sample may be tensioned under a very slight load to ensure adequate flatness. The coefficient of linear thermal expansion is the difference in lengths at the elevated temperature and the final length after cooling back to room temperature divided by the product of the final length and the temperature difference.

Substrates

Microcellular polyester foam substrates were obtained from MicroGREEN Polymers, Inc., Arlington, Wash., under the trade designation INCYCLE. The cellular substrates were obtained as 16 (or in some cases, 20) inch wide roll goods and comprised a thickness of approximately 80 mils and a density of about 0.38 grams/cc.

Conventional (non-microcellular) polyester foam substrates were obtained from ATL Composites, Southport, Australia, under the trade designation AIREX T92, and from Armacell Inc., Mebane, N.C. The AIREX foam substrates were obtained as approximately 4 foot×8 foot sheets and were sawn along their length and width to provide substrates of approximately 0.2 inches thickness. The debris from the sawing process was removed by vacuuming, thus leaving behind a fairly rough-textured surface as the result of the sawing process. The Armacell foam substrates were approximately 0.5 inches thick as received. It was estimated that the conventional foams comprised a cell size in the range of approximately 0.2-2 mm.

Biaxially-oriented polyester film substrates were obtained from 3M Company, St. Paul, Minn. The substrates were poly(ethylene terephthalate) comprising approximately 1.1-1.6 mole % di(ethylene glycol), that had been extruded onto a casting wheel and quenched, and then preheated and length oriented to a nominal machine-direction draw ratio of approximately 2.9, and transversely oriented to a nominal cross-direction draw ratio of approximately 3.7, and then annealed. The film substrates were obtained as roll goods and comprised a thickness of approximately 14 mils and a density of approximately 1.37 grams/cc. The film substrates were typically obtained at wide widths and then slit to approximately 16 inch width prior to the operations described below.

Flashlamp Treatment

Some of the (microcellular foam) cellular polyester substrates, and some of the (biaxially-oriented) polyester film substrates, were flashlamped with pulsed-ultraviolet radiation, in accordance with the general principles and procedures outlined in U.S. Pat. Nos. 5,032,209, 4,822,451 and 4,879,176. The lamp comprised an approximately 4.2 mm inner diameter, approximately 6.0 mm outer diameter, and an arc length of approximately 635 mm. The lamp was xenon filled to a nominal pressure of 200 torr, and comprised an envelope of un-doped flame-fused natural silica (type HQG-LA). The lamp was operated at 24 kV, 195 mJ/cm², at an overlap of 2×. Substrate samples were passed through the flashlamp radiation at a line speed of approximately 23 feet/minute, at a distance from the lamp of approximately 1.875 inches.

These flashlamp treatments produced a quasi-amorphous layer on the surface of the flashlamped substrate. By comparing the UV/vis spectra (as obtained via a Perkin Elmer Lambda 900 UV/vis Spectrophotometer) of the flashlamp treated film to an untreated film, the thickness of the resulting quasi-amorphous surface layer could be estimated. It was estimated that the quasi-amorphous layer was typically approximately 500 nm in thickness.

### Example 1

### Cellular to Cellular Lamination

### Flame

Two cellular polyester substrates (INCYCLE, 80 mil thickness) were passed from unwind rolls into a nip provided by a 2-roll horizontal stack, comprising two 12 inch diameter chrome plated rolls, 16 inches wide. The bonding surface of each cellular polyester substrate was a flashlamped surface. A 3D configuration flame burner of approximately 9 inch width was obtained from Flynn Burner, New Rochelle, N.Y. The burner was positioned approximately 8.5 inches away from the nip and was oriented vertically with the flame pointing toward the nip. The flame length was approximately 5-6 inches such that the flame tip was approximately 2.5-3.5 inches away from the bonding surfaces of the substrates at the contact point of the surfaces with each other. The burner was operated at a flame power of approximately 3000 BTU/hr-in, with an excess % oxygen of approximately 1.5%. The burner was thus used to heat an approximately 9 inch wide portion (stripe) of the 16 inch wide cellular substrate.

In some experiments, the nip pressure was maintained at a nominal pressure of approximately 15 psi on one roll and a nominal pressure of approximately 5 psi on the other roll and the apparatus was operated at a line speed of approximately 10 feet per minute. In other experiments, the nip pressure was maintained at approximately 20 psi on each roll, the burner flame power was approximately 8000 BTU/hr-in, and the apparatus was operated at a line speed of approximately 50 feet per minute. Excellent bonding was obtained, so as to provide cellular laminates (of the general type depicted in FIG. 3) that could be rolled up as roll goods.

### Example 2

### Cellular to Cellular Lamination

### Flame

Two cellular polyester substrates (INCYCLE, 80 mil thickness) were passed into a nip (2-roll stack) as in Example 1, with the difference being that the bonding surface of each cellular polyester substrate was not a flashlamped surface. A burner was configured as in Example 1. In some experiments, burner was operated at a flame power of approximately 3000 BTU/hr-in, the nip pressure was maintained at a nominal pressure approximately 15 psi on one roll and approximately 5 psi on the other roll, and the apparatus was operated at a line speed of approximately 10 feet per minute. In other experiments, the burner flame power was approximately 8000 BTU/hr-in, the nip pressure was maintained at approximately 20 psi on each roll, and the apparatus was operated at a line speed of approximately 50 feet per minute. Excellent bonding was obtained, so as to provide cellular laminates (of the general type depicted in FIG. 3) that could be rolled up as roll goods. It will be appreciated that the methods of Examples 1 and 2 might be used e.g. to combine any number of cellular substrates (sublayers) of any desired type, to form a cellular laminate core layer of a desired thickness and/or stiffness.

### Example 3

### Cellular to Film Lamination

### Flame

A cellular polyester substrate (INCYCLE, 80 mil thickness) and a polyester film substrate (14 mil biaxially-oriented polyester) were passed into a nip (2-roll stack) as in Example 1. Both surfaces of the cellular polyester substrate were flashlamped surfaces; a first (bonding) surface of the polyester film substrate was a flashlamped surface. A burner was configured as in Example 1. In some experiments, the burner was operated at a flame power of approximately 3000 BTU/hr-in, the nip pressure was maintained at approximately 15 psi on each roll, and the apparatus was operated at a line speed of approximately 10 feet per minute. In other experiments, the burner was operated at a flame power of approximately 8000 BTU/hr-in, the nip pressure was maintained at approximately 20 psi on each roll, and the apparatus was operated at a line speed of approximately 50 feet per minute. Excellent bonding was obtained, so as to provide cellular/film laminates that could be rolled up as roll goods.

### Example 4

### Cellular to Film Lamination

### Flame

A cellular polyester substrate (INCYCLE, 80 mil thickness) and a polyester film substrate (14 mil biaxially-oriented polyester) were bonded as in Example 3, with the difference being that the bonding surface of the cellular polyester substrate was not a flashlamped surface (the bonding surface of the polyester film substrate was a flashlamped surface). A burner was configured as in Example 1. The burner was operated at a flame power of approximately 3000 BTU/hr-in, the nip pressure was maintained at approximately 15 psi on each roll, and the apparatus was operated at a line speed of approximately 10 feet per minute. Excellent bonding was obtained, so as to provide cellular/film laminates that could be rolled up as roll goods.

### Example 5

### Cellular to Film Lamination

### Tie Layer

A polyester substrate (INCYCLE microcellular foam, 80 mil thickness) and a polyester film substrate (14 mil biaxially-oriented polyester) were passed from unwind rolls into a nip (2-roll stack) comprising a top, 12 inch diameter rubber coated roll that was operated at a nominal temperature of approximately 70 F, and a bottom, 10 inch diameter chrome-plated roll that was controlled to a nominal set point of approximately 150 F. Both surfaces of the cellular polyester substrate were flashlamped surfaces; a first (bonding) surface of the polyester film substrate was a flashlamped surface. Molten poly(ethylene terephthalate) (obtained from Eastman Chemical, Kingsport, Tenn., under the trade designation EASTAPAK 7352) was extruded from a 2.5 inch Davis Standard extruder, operating at screw speed of approximately 12.5 rpm, a melt pressure of approximately 750 psi, and at a die temperature of approximately 530 degrees F. The molten extrudate was guided into the nip between the two polyester substrates, so as to contact a first flashlamped surface of the cellular substrate, and the flashlamped bonding surface of the film substrate, in generally similar manner to the arrangement depicted in FIG. 2. The nip pressure was maintained at a nominal pressure of approximately 500 pounds and the apparatus was operated at a line speed of approximately 10 feet per minute. The polyester substrates with the molten extrudate therebetween were passed horizontally through the nip of the two-roll stack and exited the nip generally horizontally. Upon cooling of the substrates after the exited the nip, the molten extrudate solidified into a tie layer so as to form an excellent bond to both substrates. The thickness of the thus-formed tie layer was approximately 3-4 mils. Thus were formed laminates comprising one layer of 80 mil microcellular polyester foam, bonded by the tie layer to one layer of 14 mil biaxially-oriented polyester film. These cellular/film laminates could be rolled up as roll goods.

### Example 6

### Example 6a

### Film to Film Lamination

14 mil biaxially-oriented polyester film substrates were flashlamped on both sides in generally similar manner as described above, to an average flux of approximately 200 mJ/cm². The flashlamped film substrates were then passed from unwind rolls into a nip (2-roll stack) comprising metal rolls controlled to a nominal set point of approximately 375 degrees C. The nip was maintained at a nominal pressure of approximately 315 pounds per linear inch and the apparatus was operated at a line speed of approximately 0.5 feet per minute. Excellent bonding was obtained, so as to provide film/film laminates that could be rolled up as roll goods. Thus were formed two-layer (i.e., two-sublayer) film/film laminates, each laminate comprising two 14 mil biaxially-oriented polyester films self-bonded to each other.

### Example 6b

### Film/Film to Cellular Lamination

### Tie Layer

A cellular polyester substrate (AIREX T92 conventional polyester foam, sawed to 0.20 inches thickness) and a two-layer polyester film laminate substrate (the product of Example 6a) were bonded together in generally similar manner as in Example 5, by the extrusion of a molten polyester tie layer. The bonding surface of the multilayer polyester laminate substrate was a flashlamped surface. The bonding surface of the cellular polyester substrate (conventional polyester foam) was not a flashlamped surface. Since the 0.20 inch thick cellular polyester substrate was too stiff to be easily processed as a roll good, the 2-roll stack was maintained at a pressure sufficiently low that individual pieces (sheets) of the cellular polyester substrate could be fed into the nip (on the side opposite the tie layer from the 2-layer laminate substrate). The feeding of individual pieces of cellular substrate into the nip in this manner produced individual sheets of cellular substrate with a two-layer polyester laminate skin bonded to one major side and surface thereof. Such sheets could then be fed back into the nip, with the remaining exposed (bonding) surface of the cellular substrate facing the tie layer, so as to produce individual sheets of cellular substrate with a two-layer polyester laminate bonded to each major side and surface thereof.

Excellent bonding was achieved in general; however, it was found that the bonding was enhanced when the tie layer was approximately 5 mils or greater thickness, in comparison to a tie layer thickness of approximately 3 mils. (It was believed that the former case allowed the molten tie layer material to penetrate slightly further into the cells of the conventional polyester foam thus enhancing the bond). Thus were formed in one instance cellular/film laminates comprising a core layer of 0.20 inch thick polyester foam, bonded by a tie layer to a 28 mil multilayer skin (comprised of two 14-mil biaxially-oriented polyester film sublayers) on a first surface of the foam. Thus were formed in a second instance film/cellular/film laminates comprising a core layer of 0.20 inch thick polyester foam, bonded by a tie layer to a 28 mil multilayer skin (comprised of two 14-mil biaxially-oriented polyester film sublayers) on a first major surface of the foam, and likewise bonded to a similar multilayer polyester skin on a second major surface of the foam.

Similar experiments were performed, with similar results, with conventional polyester foams (of approximately 0.5 inch thickness) obtained from Armacell Inc. It will be appreciated that the methods of Examples 3 through 6 might be used e.g. to bond any suitable skin layer (whether e.g. in the form of a single film substrate, or a film laminate) to any suitable cellular substrate or cellular laminate.

### Example 7

### Cellular/Film to Cellular Lamination

### IR

A cellular/film laminate (the product of Example 5) and a cellular polyester substrate (INCYCLE microcellular foam, 80 mil thickness) were passed from unwind rolls into a nip (2-roll stack) of the type described in Example 5. The cellular/film laminate was oriented with an exposed flashlamped surface of the cellular substrate of the laminate facing outward (away from the backing roll over which it passed, i.e. so as to face, and eventually contact and bond to, a flashlamped surface of the cellular polyester substrate). An infrared (IR) lamp (obtained from Research Inc., Minneapolis, Minn., under the trade designation Model 5193 High-Intensity Infrared Elliptical Reflector with parabolic reflectors was focused at the nip interface. The IR lamp had a rated power of 1.60 kW, a heat flux of 67 Watts per linear inch, and was run at 100% power. The nip pressure was maintained at approximately 300 pounds and apparatus was operated at a line speed of approximately 3 feet per minute. Both of the rolls of the stack were operated at a nominal temperature of approximately 70 F. This process was found to form an excellent bond between the flashlamped exposed surfaces of the two cellular substrates. Thus were formed cellular/film laminates comprising a cellular layer of two cellular sublayers (each sublayer being an 80 mil thick microcellular polyester foam) bonded to each other, with one layer of biaxially-oriented polyester film bonded to the surface of one of the cellular substrates. These cellular/film laminate products (monolithic multilayer articles) could be rolled up as roll goods.

### Example 8

### Cellular/Film

### Cellular/Film Lamination

### IR

Two cellular/film laminates (each the product of Example 7) were passed from unwind rolls into a nip (2-roll stack). Each laminate was oriented with an exposed flashlamped surface of a cellular substrate of the laminate facing outward (so as to face, and eventually contact and bond to, the exposed flashlamped surface of the other cellular polyester substrate). The IR lamp of Example 7 was used in similar manner as in Example 7. This process was found to form an excellent bond between the flashlamped exposed surfaces of the two cellular substrates. Thus were formed laminates comprising a cellular layer of four cellular sublayers (each sublayer being an 80 mil thick microcellular polyester foam) bonded to each other, with one layer of 14 mil biaxially-oriented polyester film being bonded to the outermost major surfaces of the cellular layer. (That is, the formed laminates were of the general type depicted in FIG. 9 except that the cellular core layer comprised four sublayers (rather than the two sublayers of FIG. 9) and each skin layer comprised a single polyester film layer (rather than each skin layer comprising two sublayers, as in the configuration of FIG. 9). The thus-formed monolithic multilayer articles (comprising a cellular core layer flanked by first and second biaxially-oriented polyester skin layers) were too stiff to be easily rolled up as roll goods, and were typically sheeted into discrete lengths.

Articles produced by the methods of Example 8 were tested for flexural modulus by way of a three-point bending test in generally similar manner to the procedures outlined in ASTM Test Method D790-10 as specified in 2010. An Instron testing apparatus was used with a compression rated 10001b load-cell. The test fixture's loading nose and supports were free to rotate and had a radius of approximately 0.25″. The span of the fixture was 6 inches wide. The sample test specimens comprised an average thickness of approximately 0.28 inches, and were cut to 10 inches long by 1 inch wide. Five specimens were tested, at a strain rate of 1%/min. The average flexural modulus for the five samples was 267 ksi (high of 274 ksi, and low of 264 ksi).

Articles produced by the methods of Example 8 were tested for tensile shear properties by way of tests performed in generally similar manner to the procedures outlined in ASTM Test Method C273 as specified in 2007. An Instron testing apparatus was used with a 100-kN load cell. The sample test specimens were approximately 0.28 inches thick, 2 inches wide, and 4 inches long. Samples were mounted to disposable steel sheets with 3M Scotch-Weld Epoxy Adhesive DP420 with a reported shear strength of 4500 psi. Two specimens were tested, at an extension rate of 0.5 inches per minute. For each, the modulus was calculated from the linear portion of the stress-strain curve between 1 and 2% strain. The first sample exhibited a shear modulus of approximately 8.7 ksi; the second sample exhibited a shear modulus of approximately 10.9 ksi. The first specimen failed at the interface between the biaxially-oriented polyester film and the microcellular polyester foam; for the second specimen, failure occurred at the interface between the epoxy adhesive and the biaxially-oriented polyester film before failure of the polyester film—polyester foam interface. The first sample exhibited an ultimate shear strength of approximately 17,000 psi; the second sample exhibited an ultimate shear strength of approximately 12,500 psi.

### Example 9

### Thermoforming of Laminates

Skin-core-skin polyester laminates (the product of Example 8) were preheated for approximately 2 minutes between parallel metal platens set approximately 20 mm apart and maintained at a nominal temperature of approximately 200 degrees C. The preheated laminates (each being approximately 8 inches×8 inches) were manually placed between steel male/female mating molds that combined to form a parallel-walled cavity comprising a truncated hemispherical section, approximately 5 inches in diameter and with a maximum offset of approximately 1 inch (from the plano surface of the mold wall) at the radial center of the hemispherical cavity. The molding surfaces of the molds (that is, the surfaces of each mold that faced each other so as to deform the laminate therebetween) were generally parallel to, and congruent with, each other at facing locations within the cavity. The molds were not preheated.

Adhesive tape was used to tape each laminate to the bottom mold. The molds were positioned within an unheated hydraulic press (obtained from Carver, Inc., Wabash, Ind.) with the female mold on the bottom. A layer of compressible polymeric foam was positioned between the male mold and the upper platen of the press. Typically, the molds were closed together with a clamping force in the range of approximately 1000 pounds, and the parts were left clamped in the mold for approximately 5-10 minutes to cool prior to being removed. This process was found to satisfactorily thermoform an approximately 5 inch diameter portion (area) of the laminate into a truncated hemispherical protrusion comprising a first, convex surface on a first side of the laminate (as shown in the photograph of a typical thermoformed laminate found in FIG. 8), and a second, concave surface on the other side of the thermoformed portion of the laminate, the second surface being generally parallel to the first surface. The thermoformed laminate maintained this structure with little warpage or creep. The thus-produced thermoformed skin-core polyester laminates comprised an excellent combination of strength and light weight.

The tests and test results described above are intended solely to be illustrative, rather than predictive, and variations in the testing procedure can be expected to yield different results. All quantitative values in the Examples section are understood to be approximate in view of the commonly known tolerances involved in the procedures used. The foregoing detailed description and examples have been given for clarity of understanding only. No unnecessary limitations are to be understood therefrom.

It will be apparent to those skilled in the art that the specific exemplary structures, features, details, configurations, etc., that are disclosed herein can be modified and/or combined in numerous embodiments. All such variations and combinations are contemplated by the inventor as being within the bounds of the conceived invention. Thus, the scope of the present invention should not be limited to the specific illustrative structures described herein, but rather extends at least to the structures described by the language of the claims, and the equivalents of those structures. To the extent that there is a conflict or discrepancy between this specification as written and the disclosure in any document incorporated by reference herein, this specification as written will control.

What is claimed is:

1. A thermoformable monolithic multilayer article comprising:
a thermoformable cellular polyester core layer;
a first uniaxially-oriented or biaxially-oriented polyester skin layer on a first major side of the polyester core layer;
and,
a second uniaxially-oriented or biaxially-oriented polyester skin layer on a second major side of the polyester core,
wherein the core layer and the first skin layer are self-bonded to each other and wherein the core layer and the second skin layer are self-bonded to each other.

2. The article of claim 1 wherein a first major surface of the core layer and a first major surface of the first skin layer are directly melt-bonded to each other.

3. The article of claim 1 wherein a first major surface of the core layer and a first major surface of the first skin layer are indirectly melt-bonded to each other by a polyester tie layer that comprises a first major surface that is self-bonded to the first major surface of the core layer and a second major surface that is self-bonded to the first major surface of the first skin layer.

4. The article of claim 1 wherein the first and second skin layers are each at least 250 microns in thickness.

5. The article of claim 1 wherein the first skin layer comprises a first major surface that faces a first major surface of the core layer and that is an amorphous surface or a quasi-amorphous flashlamped surface.

6. The article of claim 1 wherein the core layer comprises a first major surface that faces a first major surface of the first skin layer and that is an amorphous surface or a quasi-amorphous flashlamped surface.

7. The article of claim 1 wherein a first major surface of the skin layer that faces a first major surface of the core layer, a first major surface of the second skin layer that faces a second major surface of the core layer, and the first and second major surfaces of the core layer, are all amorphous surfaces or quasi-amorphous flashlamped surfaces.

8. The article of claim 1 wherein the core layer comprises a polyester foam.

9. The article of claim 1 wherein the core layer comprises a microcellular polyester foam.

10. The article of claim 1 wherein the core layer comprises at least two thermoformable cellular polyester sublayers that are self-bonded to each other.

11. The article of claim 1 wherein at least the first skin layer comprises at least two biaxially-oriented polyester film sublayers that are self-bonded to each other.

12. The article of claim 1 wherein the first skin layer, the second skin layer, and the core layer, each consist essentially of ester-linkage polymer chains.

13. The article of claim 1 wherein the first and second skin layers and the core layer are all polyesters of like composition with a melting point within 25 degrees C. of each other.

14. The article of claim 13 wherein the polyesters of like composition are chosen from the group consisting of poly(ethylene terephthalate), poly(ethylene naphthalate), polybutylene terephthalate), and copolymers of like composition thereof.

15. The article of claim 14 wherein the polyesters of like composition all consist essentially of poly(ethylene terephthalate).

16. The article of claim 1 wherein either the core layer or the skin layers or both, consist of recycled polyester.

17. The article of claim 1 wherein the article is recyclable.

18. The article of claim 1 wherein the first skin layer and the second skin layer and the core layer are both substantially free of fibers.

19. The article of claim 1 wherein the article is substantially free of adhesive.

20. The article of claim 1 wherein the article consists essentially of:
a thermoformable cellular polyester core layer;
a first biaxially-oriented polyester skin layer on the first major side of the polyester core layer;
and,
a second biaxially-oriented polyester skin layer on the second major side of the polyester core,
wherein the polyester core layer and the first polyester skin layer are self-bonded to each other and wherein the polyester core layer and the second polyester skin layer are self-bonded to each other.

21. The article of claim 1 wherein the skin layers each have a coefficient of thermal expansion of less than 35 parts per million per degrees C. as measured over a range within +20 degrees C. to +60 degrees C.

22. The article of claim 1 wherein the multilayer article exhibits a flexural modulus of at least 0.7 GPa.

23. The article of claim 1 wherein the article comprises a density of less than 0.8 grams/cc.

24. The article of claim 1 wherein the ratio of the thickness of the first skin layer to the thickness of the core layer, is between 1:2.5 and 1:10.

25. The article of claim 1 wherein the article is a thermoformed article.
